(19) United States
(12) Patent Application Publication
(10) Pub. No.: US 2005/0139398 A1
(43) Pub. Date: Jun. 30, 2005

(54) Touch panel and method for producing the same

(75) Inventor: Michiko Endo, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 10/858,395

(22) Filed: Jun. 2, 2004

(30) Foreign Application Priority Data
Dec. 26, 2003 (JP) 2003-435504 (PAT.

(51) Int. Cl. G06K 11/06; G08C 21/00

(52) U.S. Cl. 178/18.01

(57) ABSTRACT

The present invention relates to a resistive-film-type touch panel with diodes, the touch panel being reduced in thickness, in the area for arranging the diodes, and in the height thereof. An insulating film having a predetermined thickness is formed around the resistive film which is transparent and mounted on a glass substrate facing a voltage detecting electrode film. A plurality of diodes DX1m, DX2m, DY1n and DY2n, each including a semiconductor layer produced by a screen printing or stamping printing, are disposed at a predetermined pitch and connected to first electrodes electrically connected to the transparent resistive film and second electrodes for supplying voltage. A voltage gradient is formed, in the X direction and Y direction, on the transparent resistive film when a voltage is applied to each of the diodes.

### CROSS-REFERENCE TO RELATED APPLICATION

This application claims the priority of Japanese Patent Application Number 2003-435504 filed on Dec. 26, 2003.

### BACKGROUND OF THE INVENTION

1. Field of the Invention

The present invention relates to a resistive-film-type touch panel with switching devices and to a method for producing the touch panel. More particularly, the present invention is concerned with a touch panel and a touch panel producing method capable of guaranteeing superb durability against handwriting and a long service life, simplifying incorporation of switching devices, and reducing the thickness of a panel itself.

2. Description of the Related Art

Conventionally, display devices, including liquid crystal displays, often have touch panels mounted on the display screens thereof. The inclusion of a touch panel makes it possible to directly command a computer by pressing or touching an icon or the like displayed on the display screen using a stylus or the like. Therefore, the touch panel is widely adopted for the display screens of terminal devices including-personal digital assistants (PDAS) and a point-of-sale (POS) devices.

Various types of touch panels have been used in the past. For example, Japanese Unexamined Patent Application Publication No. 59-85584 has disclosed a touch panel having a glass substrate and a transparent resin film, over which a transparent conductive film is coated, opposed to each other with a spacer between them.

In the touch panel, a first electrode is formed along two opposite sides of one of the transparent conductive film sides of the glass substrate and transparent resin film, for example, two sides thereof along an X axis. A second electrode is formed along two opposite sides of the other transparent conductive film side, for example, two sides thereof along a Y axis. In order to detect a point touched with a finger or a stylus, a y-coordinate representing the touched point is determined by applying a predetermined voltage to the first electrodes and detecting a voltage at one of the second electrodes. Likewise, an x-coordinate representing the touched point is determined by applying a predetermined voltage to the second electrodes and detecting a voltage at one of the first electrodes.

Namely, as far as the touch panel in accordance with the related art is concerned, a voltage has to be applied not only to the electrodes on the transparent conductive film coated over the glass substrate but also to the electrodes on the transparent conductive film coated over the transparent resin film. Thus, electric fields required for detecting coordinates must be included. However, if the stylus or the like is repeatedly used to press a certain point or write something, the transparent conductive film on the transparent resin film may crack. In this case, an electric field induced on the transparent conductive film on the transparent resin film distorts. This makes it hard to avoid degradation of precision in detecting a touched point.

In a touch panel proposed in, for example, Japanese Unexamined Patent Application Publication No. 5-265633, a plurality of electrodes is formed along adjoining sides of a transparent conductive film on a glass substrate. A voltage is applied to the electrodes via switching devices so that a predetermined potential gradient will occur in a planar resistance member. A point touched with a stylus or the like is detected based on the potential at the point.

The proposed resistive film type touch panel has a plurality of switching devices, for example, field-effect transistors (FETs) or diodes juxtaposed equidistantly, on the surface of a glass substrate and over which a rectangular transparent resistive film is coated, along the sides of the transparent resistive film. When a stylus comes into contact with the transparent resistive film, the switching devices disposed along opposite sides of the transparent resistive film are turned on. This causes a potential gradient to occur in the X-axis direction or Y-axis direction of the transparent resistive film. Therefore, coordinates representing a touched point can be specified by detecting the potential gradients caused along the X and Y axes by the contact of the stylus.

In the proposed resistive-film type touch panel, diodes are juxtaposed on the perimeter of the rectangular transparent resistive film. For reserving an area in the transparent resistive film for a contact sensing field, a glass substrate larger than the area of the transparent resistive film is necessary. This poses a problem in that the size of the entire touch panel becomes large. A resistive-film type touch panel that attempts to solve the problem by devising a way of arranging diodes has been proposed in, for example, Japanese Unexamined Patent Application Publication No. 6-187083.

In the proposed resistive-film-type touch panel, two parallel electrodes are formed on an insulating film disposed on the perimeter of the transparent resistive film. Diodes are interposed between the electrode layers. The width of the frame-like portion, formed around the contact sensing field, is therefore small, and the effective area of the contact sensing field is enlarged or the planar size of the entire touch panel is reduced.

However, as far as the resistive-film-type touch panels with diodes according to the related arts are concerned, a plurality of diodes each formed as a single component must be disposed on the edges of a glass substrate. This causes a reduction in the effective area of an entire touch panel. Moreover, the thickness of the touch panel increases at the frame-like perimeter thereof. The increase in the thickness becomes an obstacle to incorporation of the touch panel in a display device.

In the resistive-film-type touch panels with diodes according to the related arts, as diodes, each formed as a single component, are employed, after the diodes are mounted, the touch panels become bulky. Moreover, soldering or any other work required in order to couple the diodes to respective electrodes formed on a transparent resistive film is time-consuming. Consequently, the process of producing the touch panel becomes complex, and the cost of manufacture is hard to reduce.

The present invention attempts to solve the foregoing problems. An object of the present invention is to provide a resistive-film-type touch panel with diodes and a method of producing the touch panel. Herein, a simple method of directly forming diodes on a substrate by applying a paste material through screen printing or stamping is adopted. An area reserved for the diodes is reduced, and the thickness of the touch panel is minimized.

### SUMMARY OF THE INVENTION

In efforts to solve the foregoing problems, the present invention provides a touch panel that has a plurality of switching devices juxtaposed on an insulating film with a predetermined spacing between adjoining devices. The insulating film has a predetermined width and is formed along the sides of a transparent resistive film which is coated over a transparent substrate so that the transparent resistive film will be opposed to a potential detecting electrode. A predetermined voltage is applied to the switching devices in order to produce a potential gradient in the X-axis direction of the transparent resistive film or the Y-axis direction thereof. Herein, the switching devices are realized with laminated products each including a semiconductor layer that is formed on an electrode disposed on the insulating film according to a screen printing or a stamping technique. When the switching devices conduct, the predetermined voltage is applied to the transparent resistive film in the X-axis or Y-axis direction.

Each of the laminated products includes a Schottky barrier formed between an n-type or p-type semiconductor layer and a metal layer. A plurality of first electrodes juxtaposed with predetermined spacing between adjoining electrodes and continuously extending second electrodes are disposed along the sides of the insulating film. The laminated products are formed on the respective first electrodes, and the metal layers are extended or coupled to the second electrodes. Furthermore, the first electrodes conduct electricity to the transparent resistive film via openings bored in the insulating film.

The first electrodes and a plurality of second electrodes juxtaposed with a predetermined spacing between adjoining electrodes are disposed along the sides of the insulating film. The laminated products are formed on the first electrodes, and the metal layers are extended or coupled to the second electrodes. Furthermore, the second electrodes conduct electricity to the transparent resistive film via openings bored in the insulating film.

The laminated products are formed on the plurality of first electrodes juxtaposed with the predetermined spacing between adjoining electrodes, and the second electrodes are extended from the insulating film to the laminated products. Furthermore, the first electrodes conduct electricity to the transparent resistive film via openings bored in the insulating film.

The laminated products are formed on the first electrodes, and the second electrodes are extended from the insulating film to the laminated products. Furthermore, the second electrodes conduct electricity to the transparent resistive film via openings that are bored in the insulating film with the predetermined spacing between adjoining openings.

In the touch panel, the transparent resistive film is coated over the transparent substrate including a rectangular contact sensing field. The insulating film is formed along the first to fourth sides of the transparent resistive film so that it will enclose the contact sensing field. The plurality of switching devices is divided into the first to fourth groups of switching devices. The first to fourth groups of switching devices are disposed along the first to fourth sides of the transparent resistive film on the insulating film. The switching devices belonging to each of the first to fourth group of switching devices are coupled to the first electrodes that are juxtaposed with the predetermined spacing between adjoining electrodes and that conduct electricity to the transparent resistive film, and are also coupled to the second electrode having the predetermined voltage applied to the power feeding terminal thereof. A transparent film on which the detecting electrodes are formed is bonded to be opposed to the contact sensing field with a spacer, which is placed along the first to fourth sides of the transparent resistive film, between them. When the detecting electrode is pressed, the first and third groups of switching devices that are opposed to each other or the second and fourth groups of switching devices that are opposed to each other are alternately selected. The selected groups of switching devices are turned on when the predetermined voltage is applied to the power feeding terminals of the second electrodes to which the switching devices are coupled.

The switching devices belonging to the first to fourth groups of switching devices are realized with Schottky barrier diodes each including an n-type or p-type semiconductor layer and a metal layer. The cathodes of the diodes belonging to the first and fourth groups of switching devices are coupled to the first electrodes, and the anodes thereof are coupled to the second electrodes. The cathodes of the diodes belonging to the second and third groups of switching devices are coupled to the second electrodes, and the anodes thereof are coupled to the first electrodes.

The second electrodes to which the diodes belonging to the first to fourth groups of switching devices are coupled are formed inside the first electrodes on the insulating film. The second electrode to which the first and second groups of switching devices are coupled, and the second electrode to which the third and fourth groups of switching devices are coupled are formed continuously and coupled to the respective power feeding terminals.

At least one first electrode is selected from the plurality of first electrodes to which the diodes belonging to each of the first to fourth groups of switching devices are coupled. The selected first electrode is coupled to a wiring having an electrode voltage detecting terminal. The electrode voltage detecting terminals are juxtaposed by the side of the power feeding terminals formed on one edge of the transparent substrate. The wirings are formed outside the first electrodes on the insulating film, and link the selected first electrodes and associated detecting terminals.

In another touch panel in accordance with the present invention, the transparent resistive film coated over the transparent substrate has a rectangular contact sensing field and a power feeding field that has a predetermined width and that is formed around and isolated from the contact sensing field. The plurality of switching devices is coupled to the first electrodes formed along the sides of the contact sensing field and also coupled to the second electrodes formed in the power feeding field. The switching devices each include a semiconductor layer formed through screen printing or stamping.

The switching devices are realized with diodes each having a junction formed between n-type and p-type semiconductor layers. The junctions in the diodes are disposed on the surface of the transparent substrate having the contact sensing field and power feeding field isolated from each other.

Furthermore, the plurality of switching devices is divided into the first to fourth groups of switching devices. The first to fourth groups of switching devices are disposed on the insulating film along the first to fourth sides of the transparent resistive film. The switching devices belonging to each of the first to fourth groups of switching devices are coupled to the first electrodes that conduct electricity to the transparent resistive film and that are juxtaposed with a predetermined spacing between adjoining electrodes, and also coupled to the second electrode that has the predetermined voltage applied to the power feeding terminal thereof. The transparent film having the potential detecting electrodes formed thereon is bonded to be opposed to the contact sensing field with a spacer, which is disposed along the first to the fourth sides of the transparent resistive film, between them. When the detecting electrode is pressed, the first and third groups of switching devices that are opposed to each other or the second and fourth groups of switching devices that are opposed to each other are alternately selected. The selected groups of switching devices are turned on when the predetermined voltage is applied to the power feeding terminals of the second electrodes to which the switching devices are coupled.

Moreover, a touch panel producing method in accordance with the present invention comprises the steps of: forming an insulating film, which has a predetermined width and in which a plurality of openings that opens onto a transparent resistive film is formed with a predetermined spacing between adjoining openings, on the perimeter of the transparent resistive film coated all over a transparent substrate; forming first electrodes in the openings; forming second electrodes separated from the openings and extended along the perimeter; forming a plurality of switching devices on the first electrodes or second electrodes with the predetermined spacing between adjoining electrodes; coupling a power feeding terminal to each of the second electrodes; and bonding a transparent film, which has detecting electrodes formed thereon, to the transparent substrate with an isolating spacer between them.

The insulating film is formed by applying an insulating paste through screen printing or stamping. The first and second electrodes are formed by applying a conductive paste through screen printing or stamping.

The switching devices each include a metal layer and a semiconductor layer. After the metal layers are formed on the first electrodes or second electrodes by applying a metallic paste through screen printing or stamping, the semiconductor layers are formed by applying a semiconductor paste through screen printing or stamping so that the semiconductor layers will be layered on the metal layers and will overlie the second electrodes or first electrodes.

The metallic paste contains tungsten, and the semiconductor paste contains an n-type or p-type silicon. The layered semiconductors and metals are heated and clamped, whereby Schottky barrier diodes are formed to have as the junctions the contacts between the semiconductor layers and metal layers.

The insulating film is formed along the first to fourth sides of the transparent resistive film so that it will enclose a rectangular contact sensing field. The plurality of switching devices is divided into the first to fourth groups of switching devices. The first to fourth groups of switching devices are formed on the insulating film along the first to fourth sides of the transparent resistive film. The switching devices belonging to each of the first to fourth groups of switching devices are coupled to the first electrodes that conduct electricity to the transparent resistive film and that are juxtaposed with a predetermined spacing between adjoining electrodes, and also coupled to the second electrode having the predetermined voltage applied to the power feeding terminal thereof.

A touch panel producing method in accordance with the present invention comprises the steps of: forming an insulating film, which has a predetermined width and in which a plurality of openings that opens onto a transparent resistive film is formed with a predetermined spacing between adjoining openings, on the perimeter of the transparent resistive film coated all over a transparent substrate; forming first electrodes on the insulating film; forming switching devices on the first electrodes; forming second electrodes so that the second electrodes extend along the perimeter of the insulating film and overlie the switching devices; coupling a power feeding terminal to each of the second electrodes; and bonding a transparent film, which has detecting electrodes formed thereon, to the transparent substrate with an isolating spacer between them.

The insulating film is formed by applying an insulating paste through screen printing or stamping. The first and second electrodes are formed by applying a conductive paste through screen printing or stamping.

The switching devices each include a metal layer and a semiconductor layer. The metal layers are formed on the first electrodes or second electrode by applying a metallic paste through screen printing or stamping. Thereafter, the semiconductor layers are formed by applying a semiconductor paste through screen printing or stamping so that the semiconductor layer will be layered at least on the metal layers. The semiconductor layers and metal layers are heated and clamped, whereby the junctions of diodes are realized with the contacts between the semiconductor layers and metal layers.

The metallic paste contains tungsten, and the semiconductor paste contains an n-type or p-type silicon. Schottky barrier diodes are formed to have as the junctions the contacts between the semiconductor layers and metal layers.

The insulating film is formed along the first to fourth sides of the transparent resistive film so that it will enclose a rectangular contact sensing field. The plurality of switching devices is divided into the first to fourth groups of switching devices. The first to fourth groups of switching devices are formed on the insulating film along the first to fourth sides of the transparent resistive film. The switching devices belonging to the first and second groups of switching devices are disposed on the first electrodes that are formed in the openings bored in the insulating film, and coupled to the second electrode overlying the switching electrodes. The switching devices belonging to the third and fourth groups of switching devices are disposed on the second electrode that is formed along the perimeter of the insulating film, and coupled to the first electrodes that are formed in the openings bored in the insulating film and that overlie the switching devices.

Other touch panel producing methods in accordance with the present invention comprise the steps of: partitioning a transparent resistive film coated all over a transparent substrate into a rectangular contact sensing field and a power feeding field, which has a predetermined width and lies around the contact sensing field, with a spacing between them; forming a plurality of first electrodes on the perimeter of the contact sensing field with a predetermined spacing between adjoining electrodes, and forming second electrodes in the power feeding field; forming as a layer a plurality of switching devices with the predetermined spacing between adjoining devices so that the switching devices will be coupled to the first electrodes and second electrodes; coupling a power feeding terminal to each of the second electrodes; and bonding a transparent film, which has detecting electrodes formed thereon, to the transparent substrate with an isolating spacer between them.

The first and second electrodes are formed by applying a conductive paste through screen printing or stamping. Furthermore, first semiconductor layers having one terminal thereof coupled to the first electrodes and having the other terminal thereof located on the transparent substrate between the contact sensing field and power feeding field are formed as a layer by applying an n-type of p-type semiconductor paste through screen printing or stamping. Second semiconductor layers having one terminal thereof coupled to the second electrode and bringing the other terminal thereof into contact with the first semiconductor layers are formed as a layer by applying a p-type or n-type semiconductor paste through screen printing or stamping. Thus, diodes are formed with the junctions between the first semiconductor layers and second semiconductor layers. The semiconductor pastes contain an n-type or p-type silicon.

At the step of partitioning the transparent resistive film into the contact sensing field and power feeding field, the transparent resistive film coated over the transparent substrate is removed in order to isolate the contact sensing field from the power feeding field with the spacing between them.

Two parallel lines are scribed with the spacing between them on the perimeter of the transparent resistive film coated over the transparent substrate. After the contact sensing field and power feeding field are isolated from each other, the transparent resistive film interposed between the scribed lines is removed.

Moreover, the plurality of switching devices is divided into the first to fourth groups of switching devices. The first to fourth groups of switching devices are formed along the first to fourth sides of the contact sensing field. The switching devices belonging to each of the first to fourth groups of switching devices are coupled to the first electrodes that conduct electricity to the transparent resistive film and that are juxtaposed with the predetermined spacing between adjoining electrodes, and also coupled to the second electrode having the predetermined voltage applied to the power feeding terminal thereof.

### BRIEF DESCRIPTION OF THE DRAWINGS

Other features, objects, and advantages of the present invention will be apparent from the following description of preferred embodiments to be made with reference to the drawings in which the same reference numerals denote identical or equivalent components throughout all of the drawings, and in which:

FIG. 1 is an explanatory plan view showing the structure of a resistive-film type touch panel in accordance with one embodiment of the present invention;

FIG. 2A and FIG. 2B are explanatory sectional views showing concrete examples of a diode included in the touch panel shown in FIG. 1;

FIG. 3A and FIG. 3B are explanatory sectional views showing other concrete examples of a diode included in the touch panel shown in FIG. 1;

FIG. 4 is a flowchart describing a process of producing the touch panel shown in FIG. 1;

FIG. 5 is a flowchart showing steps of producing respective components in relation to the process of producing the touch panel described in FIG. 4 for the purpose of explaining the production of the touch panel and the assembling of the components;

FIG. 6A to FIG. 6F are explanatory sectional views showing steps of producing a diode included in the touch panel;

FIG. 7A to FIG. 7E are explanatory plan views showing steps of producing a diode included in the touch panel;

FIG. 8 is an explanatory plan view showing the structure of a resistive-film type touch panel in accordance with a variant of one embodiment of the present invention;

FIG. 9A to FIG. 9F are explanatory plan views showing steps of producing a diode included in a resistive-film type touch panel in accordance with the other embodiment of the present invention;

FIG. 10A to FIG. 10D are explanatory sectional views showing steps of producing a diode included in the touch panel in accordance with the other embodiment;

FIG. 11 is an explanatory plan view and an enlarged partial view showing the structure of a resistive-film type touch panel in accordance with the other embodiment of the present invention;

FIG. 12 is an explanatory plan view showing the structure of a diodes-inclusive touch panel in accordance with a related art; and

FIG. 13A and FIG. 13B are explanatory diagrams showing a diode included in the diodes-inclusive touch panel in accordance with the related art.

### DESCRIPTION OF THE PREFERRED EMBODIMENTS

Referring to the drawings, a resistive-film type touch panel and a touch panel producing method in accordance with one embodiment of the present invention will be described below. To begin with, prior to the description of a resistive-film type touch panel and a method of producing a touch panel in accordance with the present embodiment, the structures of resistive-film type touch panels in accordance with related arts which are the fundamentals of the present embodiment will be described in order to clarify the features and advantages of the present embodiment.

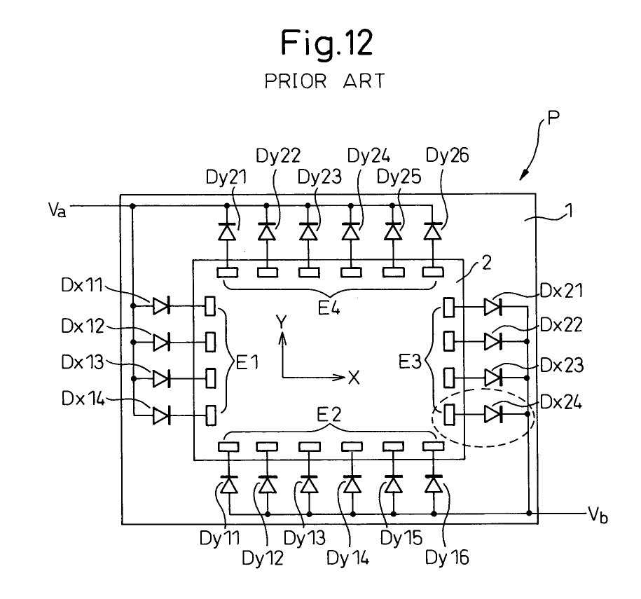

FIG. 12 shows the structure of a resistive-film type touch panel in accordance with a related art, wherein diodes are adopted as switching devices. For brevity, the plan view schematically and illustratively shows the structure of the touch panel P. Note that the shape and dimensions of an actual touch panel are not presented.

A rectangular transparent film 2 is attached to the surface of a glass substrate 1. A plurality of electrodes is disposed on the perimeter of the transparent resistive film 2 with a predetermined spacing between adjoining electrodes. In the drawing, the electrodes are expressed with blank rectangles. A plurality of electrodes is grouped together. Groups of electrodes E1 to E4 are disposed along the sides of the transparent resistive film 2. The same number of diodes as the number of electrodes belonging to each of the groups of electrodes is formed in the adjacency of each of the sides of the transparent resistive film 2. In the example shown in FIG. 12, four diodes Dx11 to Dx14 or four diodes Dx21 to Dx24 are coupled to the group of electrodes E1 or E3. Six diodes Dy11 to Dy16 or six diodes Dy21 to Dy26 are coupled to the group of electrodes E2 or E4. The number of diodes is appropriately determined according to the potential gradient.

The cathodes of the diodes Dx11 to Dx14 and the anodes of the diodes Dy21 to Dy26 are interconnected in common and connected to a voltage supply terminal Va. Moreover, the cathodes of the diodes Dy11 to Dy16 and the anodes of the diodes Dx21 to Dx24 are interconnected in common and connected to a voltage supply terminal Vb.

Assuming that a point on the transparent resistive film 2 is pressed via a transparent resin film, which includes a transparent conductive film and is not shown in FIG. 12, using a stylus, a voltage Va is applied to the voltage supply terminal Va and the voltage supply terminal Vb is grounded. This is intended to detect the position in an X-axis direction of the pressed point. A potential gradient is produced in the X-axis direction of the transparent resistive film 2, whereby the potential at the pressed point in the X-axis direction is detected. Consequently, the x-coordinate is determined. Thereafter, in order to detect the position in a Y-axis direction of the pressed point, the voltage supply terminal Va is grounded and a voltage Vb is applied to the voltage supply terminal Vb. Consequently, a potential gradient is produced in the Y-axis direction of the transparent resistive film 2, whereby the potential at the pressed point in the Y-axis direction is detected. Eventually, the y-coordinate is determined.

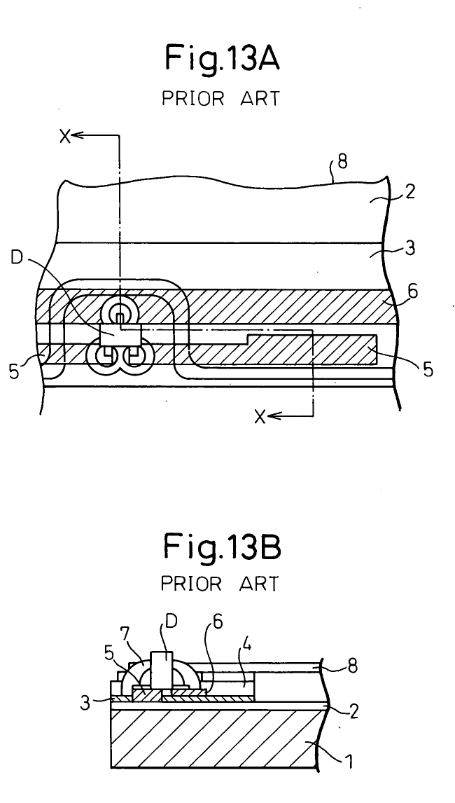

Moreover, FIG. 13A and FIG. 13B show the structure of a resistive-film type touch panel that has been proposed in the past and that has diodes disposed therein adroitly. FIG. 13A is an enlarged plan view showing a diode mounting portion of the resistive-film type touch panel. FIG. 13B is an X-X sectional view of the diode mounting portion shown in FIG. 13A. The same reference numerals are assigned to identical components.

In the resistive-film type touch panel shown in FIG. 13A and FIG. 13B, a transparent resistive film 2 is coated all over a rectangular glass substrate 1, and an insulating film 3 having a predetermined width is formed on the perimeter of the transparent resistive film 2. In other words, the insulating film 3 is formed like a frame, and a contact sensing field of the transparent resistive film 2 spreads inside the frame.

A plurality of openings is formed in the insulating film 3 with a predetermined spacing between adjoining openings. A plurality of electrodes 5 is formed in the plurality of openings so that the electrodes 5 will be coupled to the transparent resistive film 2 via the openings and extended farther. Furthermore, electrodes 6 are formed on the insulating film 3 so that they will be separated from the plurality of electrodes 5 and extended in parallel therewith. A diode D is interposed between each of the electrodes 5 and each of the electrodes 6. The terminals of each diode D are soldered to each of the electrodes 5 and each of the electrodes 6. The soldered terminals are coated with an insulating material 7.

In the example shown in FIG. 13A and FIG. 13B, the diode D includes two diodes that correspond to two adjoining diodes among the plurality of diodes juxtaposed along each side in FIG. 12. The electrodes 5 correspond to the electrodes belonging to the groups of electrodes E1 to E4. Thus, the circuitry of the resistive-film type touch panel shown in FIG. 12 is realized. A transparent resin film 8 is bonded to the glass substrate with a spacer 4 placed on the insulating film 3 between them. The contact sensing field in the transparent resistive film 2 is covered with the transparent resin film 8.

As mentioned above, as far as the resistive-film type diodes-inclusive touch panels in accordance with the related arts are concerned, a plurality of diodes formed as sole components must be disposed on the perimeter of a glass substrate. Therefore, the effective area of the touch panel gets smaller. Moreover, the thickness of the touch panel increases in the frame-like perimeter of the touch panel. The increase in the thickness becomes an obstacle to incorporation of the touch panel into a display device.

In the resistive-film type diodes-inclusive touch panels in accordance with the related arts, the diodes formed as unit components are employed. After the diodes are mounted, the touch panel becomes bulky. Moreover, the work of soldering the diodes to the electrodes formed on the transparent resistive film is time-consuming. The process of producing the touch panel is complex, and the cost of production is hardly reduced.

A resistive-film type diodes-inclusive touch panel in accordance with the present embodiment adopts a simple method of directly forming diodes on a substrate by applying a paste material through screen printing or stamping. Consequently, an area reserved for the diodes is reduced, and the thickness of the touch panel is minimized.

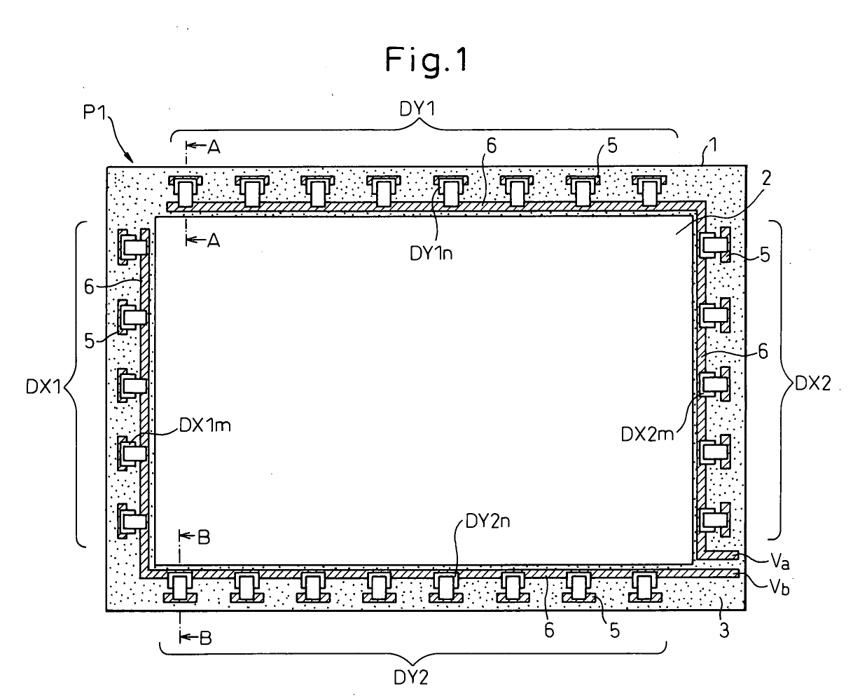

Next, the touch panel in accordance with the present embodiment of the present invention will be described in conjunction with drawings below. FIG. 1 is a plan view of the resistive-film type touch panel P1 in accordance with the embodiment. In the drawing, a transparent resin film covered over the touch panel P1 with a spacer between them is not shown.

In the touch panel P1, a transparent resistive film 2 realized with an indium-tin-oxide (ITO) film or the like is coated all over a rectangular glass substrate 1. An insulating film 3 having a predetermined width is formed on the perimeter of the transparent resistive film 2. In other words, the insulating film 3 looks like a frame. In FIG. 1, the insulating film 3 is indicated with dots. The inner portion of the transparent resistive film 2 enclosed by the frame-like insulating film 3 is bared and serves as a contact sensing field.

A plurality of first electrodes 5 coupled to the transparent resistive film 2 via openings and second electrodes 6 continuously extended in parallel with the sides of the transparent resistive film are formed on the insulating film 3. Diodes serving as switching devices are formed to link the first electrodes 5 and the second electrodes 6. In the touch panel P1 shown in FIG. 1, a group of diodes DX1 including five diodes DX1m is formed on one of two edges of the insulating film 3 that are opposed to each other in an X-axis direction. A group of diodes DX2 including five diodes DX2m is formed on the other edge thereof. Moreover, a group of diodes DY1 including eight diodes DY1n is formed on one of two edges of the insulating film 3 that are opposed to each other in a Y-axis direction. A group of diodes DY2 including eight diodes DY2n is formed on the other edge thereof.

In the example shown in FIG. 1, the five diodes DX1m or DX2m (where m denotes 1, etc., or 5) are formed in the X-axis direction, and the eight diodes DY1n or DY2n (where n denotes 1, etc., or 8) are formed in the Y-axis direction. The number of diodes may be determined appropriately but not limited to 5 or 8. The number of first electrodes 5 formed on each side of the transparent resistive film corresponds to m or n. As for the second electrodes 6 formed on the edges of the insulating film 3, each of the second electrodes 6 is extended along two adjoining edges. The ends of the second electrodes 6 are led out to the edge of the touch panel P1 as voltage supply terminals Va and Vb. The voltage supply terminals Va and Vb are, for example, as shown in FIG. 1, disposed at one of the corners of the touch panel P1.

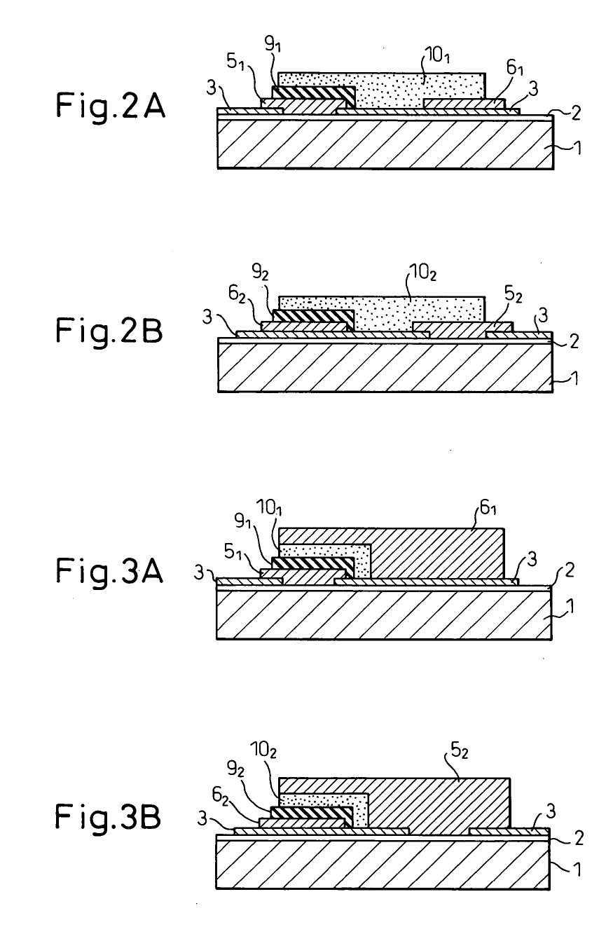

Next, the structure of the plurality of diodes incorporated in the touch panel P1 shown in FIG. 1 will be described below. FIG. 2A and FIG. 2B are longitudinal sectional views showing a concrete example of one of the plurality of diodes. FIG. 2A is an A-A sectional view of the touch panel P1 shown in FIG. 1, and FIG. 2B is a B-B sectional view thereof.

As shown in FIG. 2A, the transparent resistive film 2 is coated over the glass substrate 1, and the insulating film 3 is formed on the transparent resistive film 2. The openings via which the transparent resistive film 2 is exposed are bored in the insulating film 3. First electrodes 5₁ and a second electrode 6₁ are disposed side by side on the insulating film 3. The first electrodes 5₁ come into contact with the transparent resistive film 2 via the openings and conduct electricity to the transparent resistive film 2. Diodes are formed on the first electrodes 5₁. Metal layers 9₁ each of which is one of the components of a diode are formed on the first electrodes 5₁. P-type semiconductor layers 10₁ each of which is the other component of a diode and realizes a Schottky barrier together with the metal layer 9₁ are formed on the metal layers 9₁. The metal layers 9₁ are, for example, tungsten, and the p-type semiconductor layers 10₁ are, for example, silicon. The p-type semiconductor layers 10₁ overlie the metal layers 9₁ and extend to overlie the second electrode 6₁. The first electrodes 5₁ and second electrode 6₁ serve as the two electrodes of each diode.

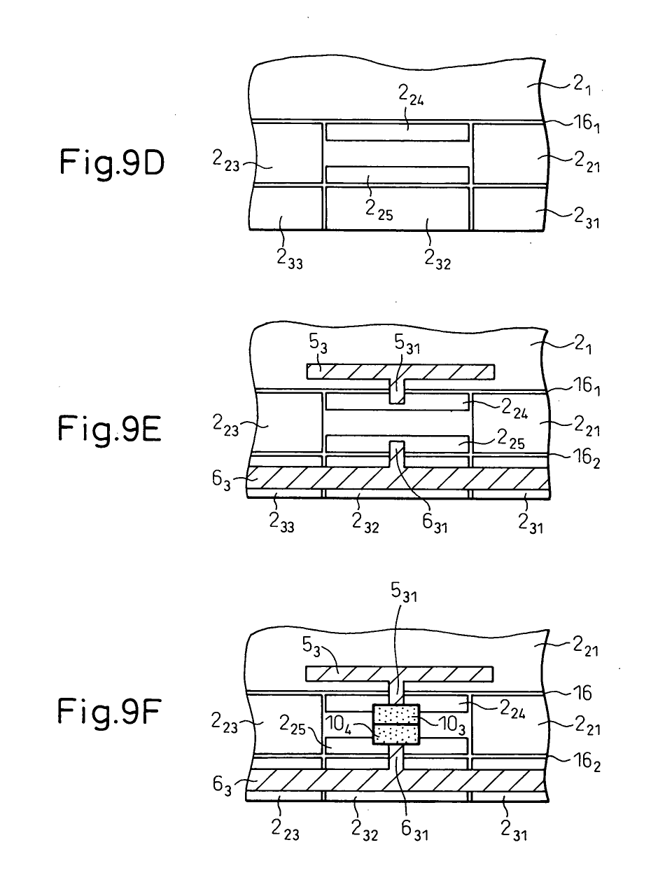

The structure of a diode shown in FIG. 2B is fundamentally identical to the structure thereof shown in FIG. 2A. A metal 9₂ and a p-type semiconductor layer 10₂ realize a Schottky barrier. As shown in FIG. 9A to FIG. 9F, the polarities of diodes formed on the opposite sides of a transparent resistive film must be the same. Therefore, the diodes whose structure is shown in FIG. 2B is formed on a second electrode 6₂, and the p-type semiconductor layers 10₂ are extended to overlie the first electrodes 5ₛ, whereby the polarity of the diodes whose structure is shown in FIG. 2A agrees with the polarity of the diodes whose structure is shown in FIG. 2B.

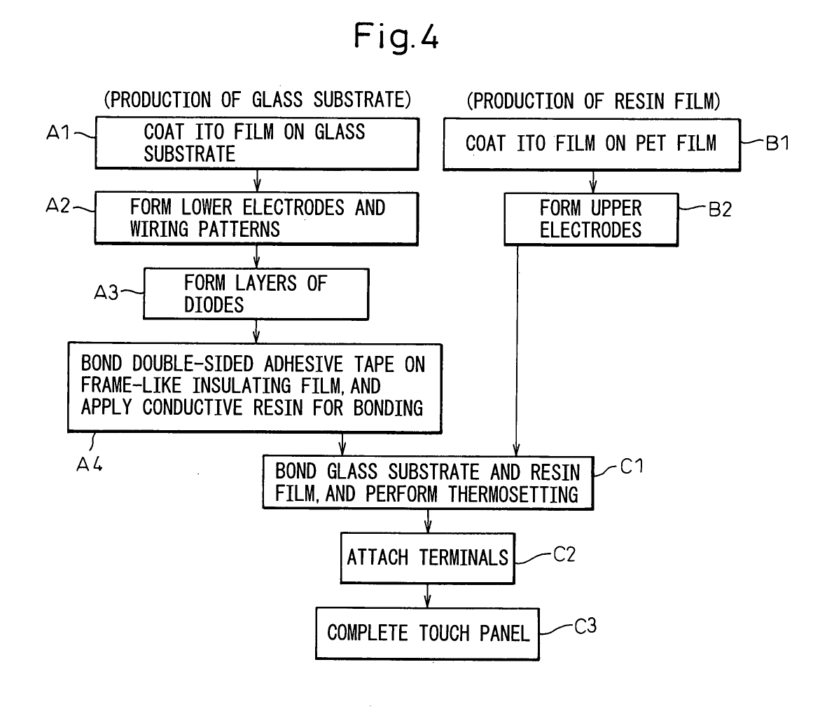

In the concrete examples of the structure of a diode shown in FIG. 2A and FIG. 2B, the second electrodes 6 are, as shown in FIG. 1, formed along the internal edges of the frame-like insulating film 3, and the plurality of first electrodes 5 is formed outside the second electrodes. Moreover, the metal layers included in the diodes are extended to overlie the first electrodes or second electrode. FIG. 3A and FIG. 3B show other concrete examples of structures different from the structures shown in FIG. 2A and FIG. 2B.

In the different concrete examples, the p-type semiconductor layers, each of which is one of the components of a diode, are not extended to be coupled to the first or second electrodes. Instead, the first electrodes or second electrode is extended to overlie the diodes. FIG. 3A shows, similarly to FIG. 2A, the A-A section of the touch panel P1 shown in FIG. 1, and FIG. 3B shows, similarly to FIG. 2B, the B-B section thereof.

Referring to FIG. 3A, similarly to FIG. 2A, the Schottky barrier diodes are formed with the metal layers 9₁ and p-type semiconductor layers 10₁ on the first electrodes 5₁. A difference from FIG. 2A lies in that part of the second electrode 6₁ disposed on the insulating film 3 in parallel with adjoining electrodes of the sides of the transparent resistive film is extended to overlie the p-type semiconductor layers 10₁. In FIG. 3B, a plurality of diodes formed with the metal layers 9₂ and p-type semiconductor layers 10₂ is formed on the second electrode 6₂ with a predetermined spacing between adjoining diodes. The first electrodes 5₂ are extended to overlap the p-type semiconductor layers 10₂ included in the respective diodes. In either of FIG. 3A and FIG. 3B, the metal layers and p-type semiconductor layers are interposed between the first and second electrodes. Consequently, the first and second electrodes are separated from each other but do not come into contact with each other.

In the foregoing concrete examples of the structure of a diode, a p-type silicon doped with boron is adopted as the semiconductor that is one of the components of a diode. An n-type silicon doped with phosphorus may be substituted for the p-type silicon. In this case, the polarities of diodes having the structures shown in FIG. 2A, FIG. 2B, FIG. 3A, and FIG. 3B are opposite to the ones attained in the concrete examines.

Referring to FIG. 2A, FIG. 2B, FIG. 3A, and FIG. 3B, the structures of a diode have been described as the structures to be adopted for the diodes DY1n belonging to the group of diodes DY1 and the diodes DY2n belonging to the group of diodes DY2 that are disposed along two sides of the touch panel P1 shown in FIG. 1 which are opposed to each other in the Y-axis direction. The diodes Dx1n belonging to the group of diodes DX1 and the diodes DX2n belonging to the group of diodes DX2 that are disposed along two opposite sides in the X-axis direction can also adopt the structures shown in FIG. 2A and FIG. 2B or FIG. 3A, and FIG. 3B.

The diodes Dy1n and Dy2n disposed along two opposite sides in the Y-axis direction, and the diodes DX1n and DX2n disposed along two opposite sides in the X-axis direction adopt the same structure. Along the two opposite sides of the touch panel on the frame-like insulating film 3, the first electrodes 5 are disposed outside the second electrodes 6. Along one of the two opposite sides, the diodes are formed on the respective first electrodes. On the other side, the diodes are formed on the second electrode. Therefore, the components of each of all the diodes incorporated in the touch panel P1, that is, the layers of each of all laminated products can be formed at the same step in a producing process. Moreover, the conducting direction of all the diodes disposed in the X-axis or the Y-axis can be arranged to a same direction.

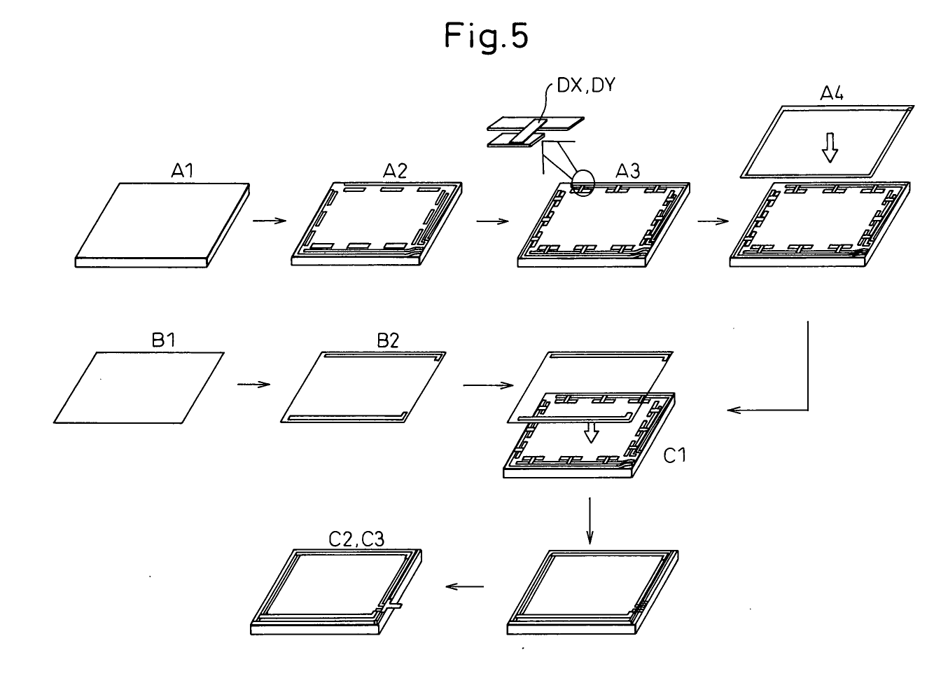

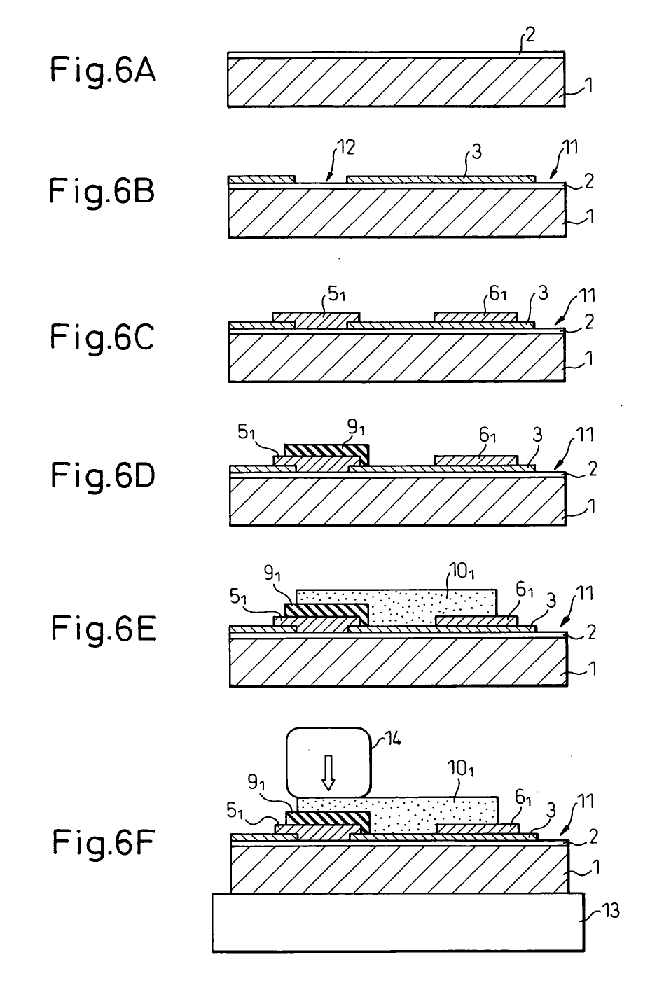

The structure of the resistive-film type touch panel in accordance with the present embodiment, and the structures of a diode adopted for the touch panel have been described so far. Next, the process of producing the resistive-film type touch panel in accordance with the present embodiment including the step of forming incorporated diodes will be described with reference to FIG. 4 to FIG. 7. FIG. 4 and FIG. 5 are flowcharts concerned with the process of producing the resistive-film type touch panel in accordance with the present embodiment. FIG. 4 describes the contents of works performed in respective steps, and FIG. 5 shows the states of the touch panel in association with the touch panel producing steps described in FIG. 4. In both the drawings, the same reference numerals are assigned to identical producing steps.

For production of the resistive-film type touch panel, first, production of a glass substrate and production of a transparent resin film are started independently of each other. The glass substrate and transparent resin film produced independently of each other are bonded to each other.

For production of a glass substrate, first, a transparent resistive film, for example, an indium-tin-oxide (ITO) film is coated all over one side of a glass substrate, which is cut to have a rectangular shape and a predetermined size, using ordinary coating equipment. After the ITO film is coated over the glass substrate, an insulating paste is applied to the perimeter of the rectangular ITO film through screen printing so that the perimeter will have a predetermined width as if to be the frame of a contact sensing field defined in the center of the ITO film. At this time, the insulating paste is applied to the perimeter of the ITO film except portions equivalent to openings which are disposed with a predetermined spacing between adjoining openings and via which first electrodes will conduct electricity to the ITO film (step A1).

After the frame-like insulating film is formed on the ITO film, lower electrodes corresponding to first electrodes 5 and each serving as one of two electrodes of a diode, and wiring patterns corresponding to second electrodes 6 and each serving as the other electrode of a diode are, as shown in FIG. 1, formed by applying a conductive paste, for example, a silver (Ag) paste through screen printing (step A2).

After the lower electrodes and wiring patterns are formed on the insulating film, a plurality of switching devices that is electrically coupled to the lower electrodes and wiring patterns is formed at the positions of the lower electrodes (step A3). For the switching devices, for example, tungsten is adopted as a metallic material, and an n-type or p-type silicon is adopted as a semiconductor material. Thus, a Schottky barrier is formed with tungsten and a silicon, and a diode that is a laminated product is completed. The plurality of diodes incorporated in a touch panel is not produced one by one. Alternatively, metal layers included in the respective diodes are formed at the same step by applying a tungsten paste through screen printing. Thereafter, semiconductor layers included therein are formed at the same step by applying a silicon paste through screen printing. The step of producing diodes will be explained later.

After the diodes are formed on the insulating film that is the frame portion of the glass substrate, one side of a double-sided adhesive tape is bonded to the frame-like insulating film so that the tape will serve as a spacer for creating a gap between the ITO film of the touch panel and the resin film serving as a transparent conductive layer. Furthermore, a conductive resin for bonding is applied to required places (step A4). Thus, the process of producing a glass substrate is completed.

For production of a transparent resin film to be bonded to a glass substrate, first, for example, a polyethylene terephthalate (PET) film is procured as a transparent resin film. A transparent conductive layer, for example, an ITO film is coated all over one side of the PET film using generally adopted coating equipment (step B1).

Thereafter, an upper electrode is formed along two opposite sides of the ITO film having the same shape as the glass substrate (step B2). The upper electrode is an electrode for use in detecting the potential at a point which is pressed with a stylus or the like and at which the portion of the transparent resistive film serving as the contact sensing field and the ITO film serving as the transparent resin film come into contact with each other. The upper electrode is a wiring pattern led out to a potential detecting terminal of the touch panel.

Incidentally, as far as production of a resin film or a PET film is concerned, if the resin film is procured at step B1, the resin film may be cut to have the same size as the glass substrate after the completion of step B2. Otherwise, if a continuous sheet of resin film is machined at step B1, after step B2 is continuously performed for each touch panel, a resin film having the same size as the glass substrate may be cut out.

After the process of producing a glass substrate and the process of producing a resin film are completed, as mentioned above, the glass substrate and PET film are bonded to each other owing to the adhesion of the double-sided tape attached to the glass substrate at step A4. The conductive resin for bonding applied at step A4 is subjected to thermosetting (step C1).

A wiring printed film having voltage supply terminals, potential detecting terminals, and other terminals T is attached (step C2), whereby the resistive-film type touch panel in accordance with the present embodiment is completed.

As mentioned above, the plurality of first electrodes can be disposed on the perimeter of the touch panel along the external edges thereof with a predetermined spacing between adjoining electrodes. The plurality of diodes and the second electrodes are formed inside the first electrodes. Consequently, the contact sensing field of the touch panel can be efficiently expanded, and potentials are uniformly distributed all over the contact sensing field. Moreover, durability to handwriting improves and a long service life ensues.

Moreover, the plurality of diodes is formed on the insulating film, which is formed on the perimeter of the touch panel, with a predetermined spacing between adjoining diodes so that the diodes will be formed to link the first electrodes and second electrode disposed along each of the sides of the touch panel. Consequently, the area that must be reserved for the diodes can be reduced. Moreover, since the diodes are each realized with a laminated product having two layers of components, and sandwiched between the glass substrate and transparent resin film, the thickness of the touch panel can be reduced. Unlike the case where diodes are incorporated as individual components, the incorporated diodes will not protrude from the outer surface of the touch panel.

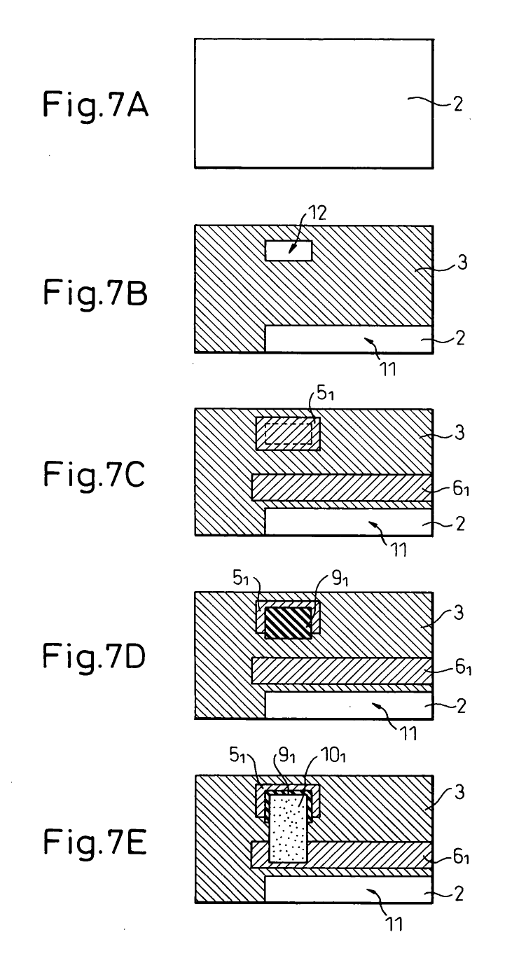

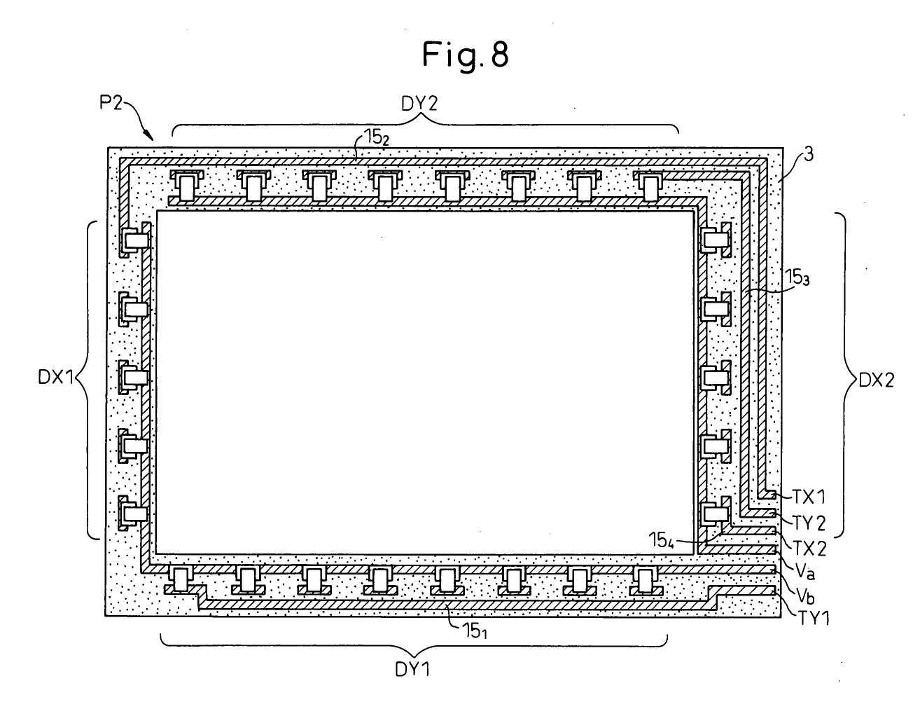

FIG. 6A to FIG. 6F are sectional views showing states of a glass substrate, or mainly, a diode attained at the steps A1 to A4 of the process of producing a resistive-film type touch panel described or shown in FIG. 4 or FIG. 5. FIG. 6A to FIG. 6F mainly show the diode mounting portion of the A-A section of the touch panel shown in FIG. 1 which is shown in FIG. 2A. FIG. 7A to FIG. 7E are plan views showing the states of the A-A section shown in FIG. 1 in relation to the states attained at respective steps and shown in FIG. 6A to FIG. 6F.

To begin with, FIG. 6A, FIG. 6B, FIG. 7A, and FIG. 7B are associated with step A1 described in FIG. 4 and associated with the states shown in FIG. 5. The transparent resistive film 2 realized with an ITO film is coated all over the glass substrate 1, and the insulating film 3 having a predetermined width is formed on the perimeter of the transparent resistive film 2. Herein, the insulating film 3 is formed by applying an insulating paste in the form of a frame on the transparent resistive film 2 except the contact sensing field 11 and the openings 12 via which the first electrodes 5 conduct electricity to the transparent resistive film 2.

FIG. 6C and FIG. 7C are associated with step A2. The first electrodes 5₁ and second electrode 6₁ are formed on the insulating film 3 by applying a silver (AG) paste through screen printing. During the screen printing, not only the first electrodes 5₁ and second electrode 6₁ but also the other first electrodes and the other second electrode are formed simultaneously. As illustrated, the first electrodes may overflow the openings 12 to overlap the insulating film 3. The positional precision may not be very high for the production of diodes.

FIG. 6D, FIG. 6E, FIG. 7D, and FIG. 7E are associated with step A3 of producing diodes. FIG. 6D and FIG. 7D show production of the metal layers 9₁, each of which serves as one of the layers constituting a laminated product that is a diode, on the first electrodes 5₁ by applying a tungsten paste through screen printing. FIG. 6D and FIG. 7D show the state of one portion of the glass substrate adopting the structure shown in FIG. 2A. All the metal layers included in all the diodes incorporated in the touch panel are formed simultaneously by applying the tungsten paste through screen printing. Therefore, in the other portion of the glass substrate adopting the structure shown in FIG. 2B, the metals 9₂ are formed on the second electrode 6₂ by applying the tungsten paste through screen printing.

Thereafter, as shown in FIG. 6E and FIG. 7E, the semiconductor layers 10₁ are produced to extend from the metal layers 9₁ to the second electrode 6₁ by applying a p-type or n-type silicon paste through screen printing. Herein, all the semiconductor layers that are included in all the diodes and each serve as one of the layers constituting a laminated product which is a diode are produced at the same step by applying the p-type or n-type silicon paste through screen printing. Even the semiconductor layers 10₂ are produced to extend from the metal layers 9₂ to the first electrodes 5₂.

By following the steps associated with FIG. 6D and FIG. 6E and FIG. 7D and FIG. 7E, the laminated products formed with the metal layers and semiconductor layers are formed on the first electrodes or second electrode. In this state, the metal layers and semiconductor layers are merely in contact with each other, and the contacts between the metal layers and semiconductor layers do not work as satisfactory Schottky barriers. Therefore, as shown in FIG. 6F, the glass substrate 1 is placed on a heating station, and a heating head 14 is abutted on the top of the laminated products that should have the Schottky barriers formed therein. Through the heating, the contact between two layers constituting each laminated product fills the role of a Schottky barrier.

As mentioned above, steps A1 to A3 are executed in order to produce the glass substrate included in the resistive-film type touch panel in accordance with the present embodiment. The steps associated with the states shown in FIG. 6A to FIG. 6B and FIG. 7A to FIG. 7E are adapted to the structures of a diode shown in FIG. 2A and FIG. 2B but cannot be adapted to the structures of a diode shown in FIG. 3A and FIG. 3B as they are. For the structures shown in FIG. 3A and FIG. 3B, the foregoing steps are modified.

When the structures of a diode shown in FIG. 3A and FIG. 3B are adopted, at the step associated with FIG. 6C and FIG. 7C, the first electrodes 5₁ and second electrode 6₂ alone are formed but the second electrode 6₁ and first electrodes 5₂ are not. At the step associated with FIG. 6D, FIG. 6E, FIG. 7D, and FIG. 7E, the metal layers are formed on the first electrodes 5₁ and second electrode 6₂ and the semiconductor layers 10₁ and 10₂ are formed on the metal layers alone, whereby laminated products are completed. After the laminated products are completed, a step is inserted in order to form the first electrodes 5₂ and second electrode 6₁.

According to the aforesaid method of producing the resistive-film type touch panel in accordance with the present embodiment, for the formation of the layers realized with the insulating film, the first electrodes, the second electrodes, and the layers of the components of the diodes that are laminated products, the procedure of applying the paste material to a plurality of predetermined places or a predetermined range on the entire surface of the touch panel according to a screen printing technique, and then drying and solidifying the paste is adopted. However, the formation of the layers is not limited to the procedure based on the screen printing technique. Alternatively, a stamping technique may be adopted for application of a paste material to a plurality of predetermined places or a predetermined range. Moreover, for formation of the first and second electrodes, not only the screen printing technique of applying a silver (Ag) conductive paste but also an ordinary metallic thin film coating technique such as a deposition or a sputtering technique may be adopted.

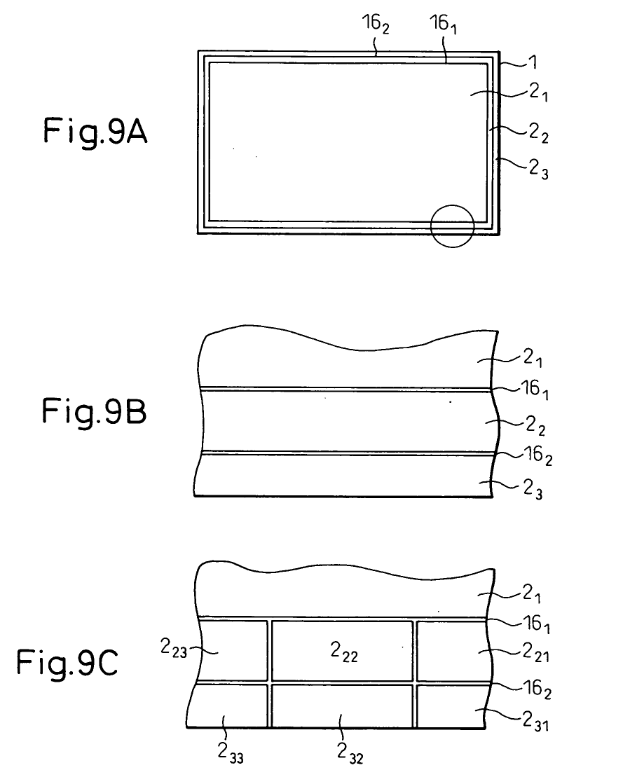

FIG. 8 shows a variant of the aforesaid embodiment including an electrode voltage detecting terminal via which an electrode voltage is monitored during operation of the resistive-film type touch panel in accordance with the embodiment shown in FIG. 1. FIG. 8 is a plan view of a resistive-film type touch panel P2. The structure of the touch panel P2 is fundamentally identical to that of the resistive-film type touch panel P1 shown in FIG. 1. The same reference numerals as those employed in FIG. 1 are assigned to the fundamental components but are not written in FIG. 8.

A difference of the structure of the resistive-film type touch panel P2 shown in FIG. 8 from that of the touch panel P1 lies in that electrode voltage detecting terminals TX1, TX2, TY1, and TY2 and wirings 15₁ to 15₄ terminated by the terminals are included for monitoring electrode voltages in the X-axis and Y-axis directions.

The electrode voltage detecting terminals TX1, TX2, TY1, and TY2 are juxtaposed together with the voltage supply terminals Va and Vb on a planar basis along one edge of the touch panel. The wirings 15₁ to 15₄ have one ends thereof coupled to the electrode voltage detecting terminals, and have the other ends thereof coupled to the first electrodes serving as the electrodes included in the diodes that are the extremities of the respective groups of diodes DX1, DX2, DY1, and DY2.

The wirings 15₁ to 15₄ are extended in parallel with the external edges of the frame-like insulating film 3 outside the plurality of first electrodes 5 in such a manner that they will not intersect one another. The wirings 15₁ to 15₄ are formed concurrently with the first and second electrodes at step A2 of the resistive-film type touch panel producing process, which is described in FIG. 4 and associated with the states shown in FIG. 5, according to the same printing technique.

Assuming that diodes are incorporated in the touch panel according to the structure of a diode shown in FIG. 2A and FIG. 2B, the wirings 15₁ to 15₄ are formed concurrently with the first electrodes 5 and second electrodes 6 at the step associated with the state shown in FIG. 6C. Moreover, assuming that diodes are incorporated in the touch panel according to the structures of a diode shown in FIG. 3A and 3B, the wirings 15₁ to 15₄ may be formed concurrently with the first electrodes 5 or the second electrodes 6.

The resistive-film type diodes-inclusive touch panel in accordance with the embodiment of the present invention has been described so far. In the embodiment, a plurality of diodes is directly formed on an insulating film on the frame-like perimeter of a transparent resistive film coated over a glass substrate, which is a base of a touch panel, according to the screen printing or stamping technique.

The resistive-film type diodes-inclusive touch panel producing process in accordance with the embodiment requires a step of forming the insulating film on the frame-like perimeter of the transparent resistive film coated over the glass substrate. According to other embodiment, the formation of the insulating film is omitted, but the plurality of diodes is directly formed on the perimeter of the transparent resistive film coated over the glass substrate, which is the base of the touch panel, according to the screen printing or stamping technique. The embodiment will be described below.

In the resistive-film type diodes-inclusive touch panel according to the present embodiment, a plurality of diodes is formed directly on the perimeter of a transparent resistive film coated over a glass substrate without intervention of an insulating film. As the plurality of diodes and transparent resistive film must be isolated from each other, the transparent resistive film coated over the glass substrate is removed from a predetermined range within which the diodes are formed.

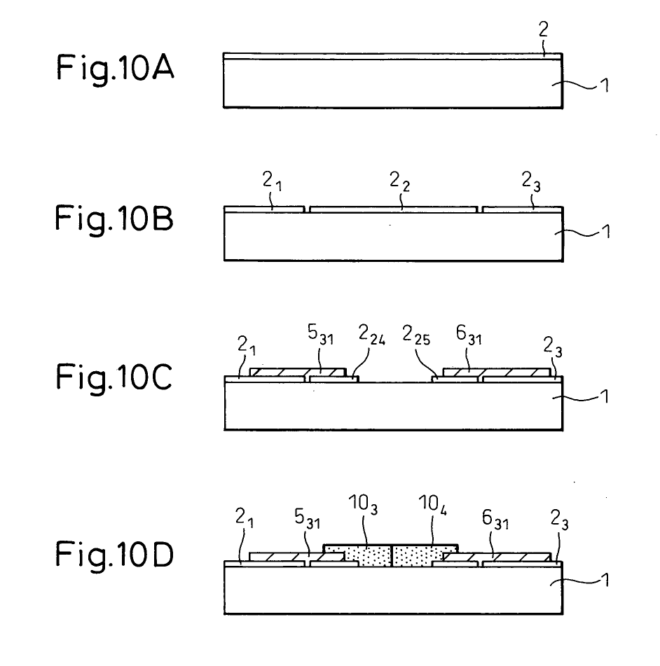

FIG. 9A to FIG. 9F are plan views showing the states of diodes incorporated the resistive-film type diodes-inclusive touch panel in accordance with the present embodiment of the present invention which are attained at steps in a producing process. FIG. 10A to FIG. 10D are sectional views showing the states of the diodes incorporated in the touch panel which are attained at the steps of the producing process. In FIG. 9A to FIG. 9F and FIG. 10A to FIG. 10D, the same reference numerals are assigned to identical components.

To begin with, as shown in FIG. 7A, a transparent resistive film 2 is coated over one side of a rectangular glass substrate 1. Two parallel lines 16₁ and 16₂ are, as shown in FIG. 9A, scribed in the perimeter of the transparent resistive film 2 using, for example, laser light. The transparent resistive film is burned away along the scribed lines. Consequently, the glass substrate 1 is partitioned into a contact sensing area 2₁ that is a center area, a diode forming area 2₂ that extends outside the contact sensing area 2₁, and a power feeding area 2₃ that extends outside the diode forming area 2₂ so that the areas will be isolated from one another. FIG. 9B and FIG. 10B are enlarged views of an encircled portion of FIG. 9A.

Thereafter, lines 16₃ and 16₄ are scribed in the diode forming area 2₂ orthogonally to the scribed lines 16₁ and 16₂, which define the range in which diodes will be formed, using, for example, laser light. Consequently, the diode forming area 2₂ is divided into subareas 2₂₁, 2₂₂, and 2₂₃ so that the subareas will be isolated from one another. FIG. 9C shows the state attained. Herein, the subareas 2₂₂ are disposed with a predetermined spacing between adjoining areas within the diode forming area 2₂ on the perimeter of the transparent resistive film 2, and diodes are formed in the respective subareas 2₂₂. The scribed lines 16₃ and 16₄ may further divide the power feeding area 2₃ into a plurality of subareas 2₃₁, 2₃₂, and 2₃₃ or may divide only the diode forming area 2₂ into the subareas.

Thereafter, the transparent resistive film is removed from the subareas 2₂₂ within the diode forming area 2₂ while being left intact in first semiconductor terminal areas 2₂₄ and second semiconductor terminal areas 2₂₅. Thus, the surface of the glass substrate 1 is bare in the subareas 2₂₂. Semiconductors included in diodes are formed on the bared surface portions of the glass substrate 1. Incidentally, the transparent resistive film may be removed entirely from the subareas 2₂₂ without being left intact in the first semiconductor terminal areas 2₂₄ and second semiconductor terminal areas 2₂₅. When diodes are formed without removal of the transparent resistive film from the subareas 2₂₂, a insulating film must be formed on the transparent resistive film within the diode forming field in order to ensure isolation.

Thereafter, as shown in FIG. 9E and FIG. 10C, a plurality of first electrodes 5₃ that is disposed on the perimeter of the contact sensing field with a predetermined spacing between adjoining electrodes, and second electrodes 6₃ that extend along the edges of the glass substrate 1 for the purpose of supplying a voltage are formed as layers by applying a conductive paste through screen printing or stamping. Herein, semiconductor terminal electrodes 5₃₁ are simultaneously formed to extend from the respective first electrodes 5₃ to the respective first semiconductor terminal areas 2₂₄ so that each semiconductor terminal electrode and each first electrode will be disposed like a letter T. A plurality of semiconductor terminal electrodes 6₃₁ is formed with a predetermined spacing between adjoining electrodes so that the semiconductor terminal electrodes will extend from the second electrode 6₃ to the second semiconductor terminal areas 2₂₅.

Thereafter, as shown in FIG. 9F and FIG. 10D, first semiconductor layers 10₃ are formed as a layer to extend from the ends of the semiconductor terminal electrodes 5₃₁ to the bared glass substrate portions by applying a semiconductor paste through screen printing or stamping. Second semiconductor layers 10₄ are then formed as a layer to extend from the ends of the semiconductor terminal electrodes 6₃₁ to the bared glass substrate portions by applying a semiconductor paste through screen printing or stamping. Herein, the ends of the second semiconductor layers 10₄ are brought into contact with the respective first semiconductor layers 10₃.

The ends of the first semiconductor layers 10₃ are in contact with the ends of the second semiconductor layers 10₄, whereby the junctions of diodes are created. Herein, the end surfaces of the first semiconductor layers may be in contact with those of the second semiconductor layers or the ends of the first semiconductor layers and those of the second semiconductors may be superposed on each other. The semiconductor pastes employed contain either an n-type or p-type silicon. Moreover, for formation of diodes, a combination of a semiconductor paste and a metallic paste may be, as shown in FIG. 2A, FIG. 2B, FIG. 3A, and FIG. 3B, substituted for the two kinds of semiconductor pastes.

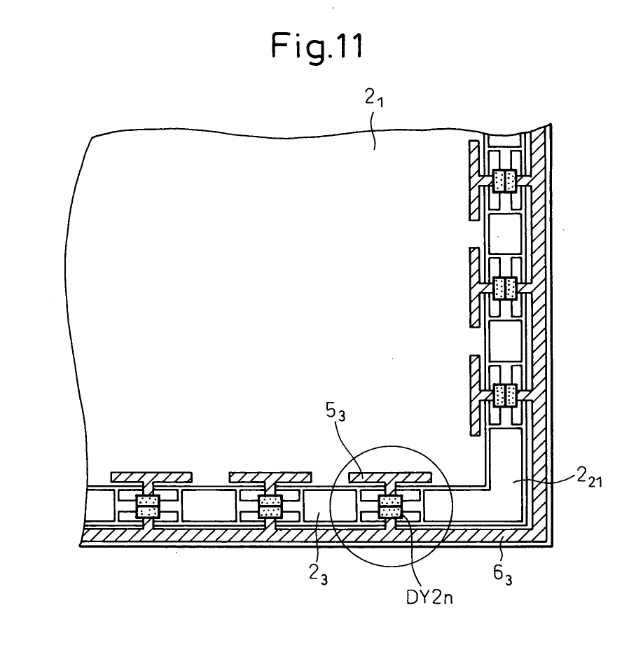

As mentioned above, after the plurality of diodes is formed on the frame-like perimeter of the glass substrate 1, an insulating film is attached to the frame-like perimeter except the contact sensing field. Thus, the process of producing a glass substrate is completed. FIG. 11 is a plan view showing in enlargement part of a glass substrate included in the resistive-film type touch panel in accordance with the present embodiment of the present invention, wherein the attached insulating film is not shown. An encircled portion of FIG. 11 corresponds to the encircled portion of FIG. 9A, showing a diode DY2n similarly to FIG. 1.

The mounting of the components of the resistive-film type touch panel on the glass substrate is completed as mentioned above. The succeeding step of assembling the glass substrate and a transparent film constituting the resistive-film type touch panel are identical to the one included in the process of producing a touch panel shown in FIG. 5. However, the procedure from step A1 to step A3 is replaced with the foregoing process of producing the components to be incorporated in the glass substrate according to the present embodiment.

As mentioned above, according to the present invention, a plurality of diodes is directly formed on a frame-like insulating film in the perimeter of a glass substrate that is a base of a touch panel, or directly formed in a frame-like perimeter of a transparent resistive film coated over the glass substrate according to the screen printing or stamping technique. Consequently, an area to be reserved for diodes can be reduced, and the height of the diodes can be lowered. Thus, a diodes-inclusive touch panel having a large effective area and a narrow frame-like perimeter is realized.

According to the present invention, a plurality of diodes is directly formed in a frame-like perimeter of a glass substrate that is a base of a touch panel by applying a semiconductor paste and a metallic paste through screen printing. Owing to the adoption of the simple producing method, any special equipment is not needed for production of semiconductor layers. Furthermore, soldering need not be performed for mounting of diodes. This results in improved mass productivity and the reduced cost of production.

1. A touch panel having a transparent resistive film coated over a transparent substrate and opposed to potential detecting electrodes, and having a plurality of switching devices, via which a predetermined voltage is applied in order to produce a potential gradient in an X-axis or Y-axis direction of said transparent resistive film, juxtaposed along the sides of said transparent resistive film with a predetermined spacing between adjoining devices, wherein:
said plurality of switching devices includes semiconductor layers that are coupled to first electrodes which are coupled to said transparent resistive film and which are formed along the sides of said transparent resistive film with the predetermined spacing between adjoining electrodes, and that are also coupled to second electrodes extending in parallel with said first electrodes on said transparent substrate; and
when said switching devices conduct, said predetermined voltage is applied to said transparent resistive film in said X-axis or Y-axis direction.

2. A touch panel according to claim 1, further comprising an insulating film that has a predetermined width and is formed along the sides of said transparent resistive film, wherein:
said plurality of switching devices is realized with laminated products including semiconductor layers that are coupled to said first electrodes and second electrodes formed on said insulating film and that are formed according to the screen printing or stamping technique.

3. A touch panel according to claim 2, wherein said laminated products each have a Schottky barrier formed with an n-type or p-type semiconductor layer and a metal layer.

4. A touch panel according to claim 3, wherein said laminated products are formed on said first electrodes, and said metal layers are extended or coupled to said second electrodes.

5. A touch panel according to claim 4, wherein said first electrodes conduct electricity to said transparent resistive film via openings bored in said insulating film.

6. A touch panel according to claim 2, wherein said first electrodes and a plurality of second electrodes juxtaposed with said predetermined spacing between adjoining electrodes are disposed on said insulating film along the sides of said transparent resistive film.

7. A touch panel according to claim 6, wherein said laminated products are formed on said first electrodes, and said metal layers are extended or coupled to said second electrodes.

8. A touch panel according to claim 7, wherein said second electrodes conduct electricity to said transparent resistive film via openings bored in said insulating film.

9. A touch panel according to claim 2, wherein said laminated products are formed on said plurality of first electrodes juxtaposed with said predetermined spacing between adjoining electrodes, and said second electrodes are extended from said insulating film to overlie said laminated products.

10. A touch panel according to claim 9, wherein said first electrodes conduct electricity to said transparent resistive film via openings bored in said insulating film.

11. A touch panel according to claim 2, wherein said laminated products are formed on said first electrodes, and said second electrodes are extended from said insulating film to overlie said laminated products.

12. A touch panel according to claim 11, wherein said second electrodes conduct electricity to said transparent resistive film via openings that are bored in said insulating film with said predetermined spacing between adjoining openings.

13. A touch panel according to claim 2, wherein:
said transparent resistive film is coated over said transparent substrate and has a rectangular contact sensing field;
said insulating film is formed along the first to fourth sides of said transparent resistive film in order to enclose said contact sensing field;
said plurality of switching devices is divided into the first to fourth groups of switching devices, and said first to fourth groups of switching devices are disposed on said insulating film along the first to fourth sides of said transparent resistive film;
said plurality of switching devices belonging to each of said first to fourth groups of switching devices is coupled to said first electrodes, which conduct electricity to said transparent resistive film and are juxtaposed with the predetermined spacing between adjoining electrodes, and also coupled to said second electrode having said predetermined voltage applied to a power feeding terminal thereof;
a transparent film having said potential detecting electrodes formed thereon is bonded to be opposed to said contact sensing field with a spacer, which is extended along said first to fourth sides of said transparent resistive film, between them;
when said detecting electrode is pressed, said first and third groups of switching devices that are opposed to each other or said second and fourth groups of switching devices that are opposed to each other are alternately selected; and
when said predetermined voltage is applied to said power feeding terminals of said second electrodes to which said selected groups of switching devices are coupled, said selected groups of switching devices are turned on.

14. A touch panel according to claim 13, wherein:
said switching devices belonging to said first to fourth groups of switching devices are realized with Schottky barrier diodes each including an n-type or p-type semiconductor layer and a metal layer;
the cathodes of said diodes belonging to said first and fourth groups of switching devices are coupled to said first electrodes, and the anodes thereof are coupled to said second electrodes; and
the cathodes of said diodes belonging to said second and third groups of switching devices are coupled to said second electrodes, and the anodes thereof are coupled to said first electrodes.

15. A touch panel according to claim 14, wherein:
said second electrodes to which said diodes belonging to said first to fourth groups of switching devices are coupled are formed inside said first electrodes on said insulating film; and
said second electrode to which said first and second groups of switching devices are coupled and said second electrode to which said third and fourth groups of switching devices are coupled are continuously formed and coupled to respective power feeding terminals.

16. A touch panel according to claim 15, wherein:
at least one first electrode is selected from said plurality of first electrodes coupled to each of said first to fourth groups of switching devices; and
said selected first electrodes are coupled to respective wirings each having an electrode voltage detecting terminal.

17. A touch panel according to claim 16, wherein:
said electrode voltage detecting terminals are juxtaposed by the side of said power feeding terminals on one edge of said transparent substrate; and
said wirings are formed outside said first electrodes on said insulating film, and link said selected first electrodes and said detecting terminals associated with said selected first electrodes.

18. A touch panel according to claim 1, wherein:
said transparent resistive film coated over said transparent substrate has a rectangular contact sensing field and a power feeding field that has a predetermined width and that is formed around and isolated from said contact sensing field; and
said plurality of switching devices is coupled to said first electrodes formed around said contact sensing field and also coupled to said second electrodes formed in said power feeding field, and each includes a semiconductor layer formed according to the screen printing or stamping technique.

19. A touch panel according to claim 18, wherein said switching devices are realized with diodes each having a junction formed between an n-type semiconductor layer and a p-type semiconductor layer.

20. A touch panel according to claim 19, wherein the junctions of said diodes are disposed on said transparent substrate on which said contact sensing field and power feeding field are formed to be isolated from each other.

21. A touch panel according to claim 18, wherein:
said plurality of switching devices is divided into the first to fourth groups of switching devices, and said first to fourth groups of switching devices are disposed on said insulating film along the first to fourth sides of said transparent resistive film;
said plurality of switching devices belonging to each of said first to fourth groups of switching devices is coupled to said first electrodes that conduct electricity to said transparent resistive film and that are juxtaposed with a predetermined spacing between adjoining electrodes, and also coupled to said second electrode having said predetermined voltage applied to the power feeding terminal thereof;
a transparent film having said potential detecting electrodes formed thereon is bonded to be opposed to said contact sensing field with a spacer, which is formed along the first to fourth sides of said transparent resistive film, between them;
when said detecting electrode is pressed, said first and third groups of switching devices that are opposed to each other or said second and fourth groups of switching devices that are opposed to each other are alternately selected; and
when said predetermined voltage is applied to said power feeding terminals of said second electrodes to which said selected groups of switching devices are coupled, said selected groups of switching devices are turned on.

22. A touch panel producing method comprising the steps of:
forming an insulating film, which has a predetermined width and in which a plurality of openings that opens onto a transparent resistive film is bored with a predetermined spacing between adjoining openings, on the perimeter of said transparent resistive film coated all over a transparent substrate;
forming first electrodes in said openings;
forming second electrodes, which are separated from said openings, on the perimeter of said transparent resistive film;
forming a plurality of switching devices on said first electrodes or second electrode with said predetermined spacing between adjoining devices;
coupling a power feeding terminal to each of said second electrodes; and
bonding a transparent film, which has detecting electrodes formed thereon, to said transparent substrate with an isolating spacer between them.

23. A touch panel producing method according to claim 22, wherein said insulating film is formed by applying an insulating paste through screen printing or stamping.

24. A touch panel producing method according to claim 22, wherein said first and second electrodes are formed by applying a conductive paste through screen printing or stamping.

25. A touch panel producing method according to claim 22, wherein:
said switching devices each include a metal layer and a semiconductor layer;
after said metal layers are formed on said first electrodes or second electrode by applying a metallic paste through screen printing or stamping, said semiconductor layers are formed by applying a semiconductor paste through screen printing or stamping so that said semiconductor layers will be laminated on said metal layers and overlie said second electrode or first electrodes.

26. A touch panel producing method according to claim 25, wherein said metallic paste contains tungsten, and said semiconductor paste contains an n-type or p-type silicon.

27. A touch panel producing method according to claim 25, wherein said semiconductor layers and metal layers that are laminated are heated and clamped in order to form Schottky barrier diodes including as the junctions thereof the contacts between said semiconductor layers and said metal layers.

28. A touch panel producing method according to claim 22, wherein:
said insulating film is formed along the first to fourth sides of said transparent resistive film so that said insulating film will enclose a rectangular contact sensing field;
said plurality of switching devices is divided into the first to fourth groups of switching devices, and said first to fourth groups of switching devices are formed on said insulating film along said first to fourth sides of said transparent resistive film; and
said plurality of switching devices belonging to each of said first to fourth groups of switching devices is connected to said first electrodes that conduct electricity to said transparent resistive film and that are juxtaposed with a predetermined spacing between adjoining electrodes, and also coupled to said second electrode that has said predetermined voltage applied to the power feeding terminal thereof.

29. A touch panel producing method comprising the steps of:
forming an insulating film, which has a predetermined width and in which a plurality of openings that opens onto a transparent resistive film is bored with a predetermined spacing between adjoining openings, on the perimeter of said transparent resistive film coated all over a transparent substrate;
forming first electrodes on said insulating film;
forming switching devices on said first electrodes;
forming second electrodes on said insulating film formed on said perimeter of said transparent resistive film so as to include a second electrode that overlies said switching devices;
coupling a power feeding terminal to each of said second electrodes; and
bonding a transparent film, which has detecting electrodes formed thereon, to said transparent substrate with an isolating spacer between them.

30. A touch panel producing method according to claim 29, wherein said insulating film is formed by applying an insulating paste through screen printing or stamping.

31. A touch panel producing method according to claim 29, wherein said first and second electrodes are formed by applying a conductive paste through screen printing or stamping.

32. A touch panel producing method according to claim 29, wherein:
said switching devices each include a metal layer and a semiconductor layer;
after said metal layers are formed on said first electrodes or second electrode by applying a metallic paste through screen printing or stamping, said semiconductor layers are formed by applying a semiconductor paste through screen printing or stamping so that said semiconductor layers will be laminated at least on said metal layers; and
said semiconductor layers and said metal layers are heated and clamped in order to form the junctions of diodes with the contacts between said semiconductor layers and said metal layers.

33. A touch panel producing method according to claim 32, wherein:
said metallic paste contains tungsten, and said semiconductor paste contains an n-type or p-type silicon; and
Schottky barrier diodes are formed to include as the junctions thereof the contacts between said semiconductor layers and said metal layers.

34. A touch panel producing method according to claim 29, wherein:
said insulating film is formed along the first to fourth sides of said transparent resistive film so that said insulating film will enclose a rectangular contact sensing field;
said plurality of switching devices is divided into the first to fourth groups of switching devices, and said first to fourth groups of switching devices are formed on said insulating film along the first to fourth sides of said transparent resistive film;
said switching devices belonging to said first and second groups of switching devices are formed on said first electrodes formed in said openings bored in said insulating film, and coupled to said second electrode that overlies said switching devices;
said switching devices belonging to said third and fourth groups of switching devices are formed on said second electrode that is extended on said insulating film formed on the perimeter of said transparent resistive film, and coupled to said first electrodes that are formed in said openings bored in said insulating film and that overlie said switching devices.

35. A touch panel producing method comprising the steps of:
partitioning a transparent resistive film, which is coated all over a transparent substrate, into a rectangular contact sensing field and a power feeding field that has a predetermined width and encloses said contact sensing field;
forming a plurality of first electrodes around said contact sensing field with a predetermined spacing between adjoining electrodes, and forming second electrodes so that said second electrodes will extend on said power feeding field;
forming a plurality of switching devices as a layer with the predetermined spacing between adjoining devices so that the switching devices will be coupled to said first electrodes and second electrodes;
coupling a power feeding terminal to each of said second electrodes; and
bonding a transparent film, which has detecting electrodes formed thereon, to said transparent substrate with an isolating spacer between them.

36. A touch panel producing method according to claim 35, wherein said first and second electrodes are formed by applying a conductive paste through screen printing or stamping.

37. A touch panel producing method according to claim 35, wherein:
first semiconductor layers having one terminals thereof connected to said first electrodes and having the other terminals thereof disposed on said transparent substrate between said contact sensing field and power feeding field are formed as a layer by applying an n-type or p-type semiconductor paste through screen printing or stamping;
second semiconductor layers having one terminals thereof coupled to said second electrodes and bringing the other terminals thereof into contact with said first semiconductor layers are formed as a layer by applying a p-type or n-type semiconductor paste through screen printing or stamping; and
diodes having the junctions thereof formed between said first semiconductor layers and said second semiconductor layers are thus formed.

38. A touch panel producing method according to claim 37, wherein said semiconductor paste contains an n-type or p-type silicon.

39. A touch panel producing method according to claim 35, wherein said transparent resistive film coated over said transparent substrate is removed at a step of isolating said contact sensing field from said power feeding field, and said contact sensing field and said power feeding field are thus isolated from each other with said spacing between them.

40. A touch panel producing method according to claim 39, wherein after two parallel lines are scribed with said spacing between them on the perimeter of said transparent resistive film coated over said transparent substrate in order to isolate said contact sensing field and said power feeding field from each other, and said transparent resistive film interposed between said scribed lines is removed.

41. A touch panel producing method according to claim 35, wherein:
said plurality of switching devices is divided into first to fourth groups of switching devices, and said first to fourth groups of switching devices are formed around said contact sensing field along the first to fourth sides of said transparent resistive film;
said switching devices belonging to each of said first to fourth groups of switching devices are coupled to said first electrodes that conduct electricity to said transparent resistive film and that are juxtaposed with a predetermined spacing between adjoining electrodes, and also coupled to said second electrode having said predetermined voltage applied to a power feeding terminal thereof.
